(19) United States
(12) Patent Application Publication
(10) Pub. No.: US 2026/0243902 A1
(43) Pub. Date: Aug. 20, 2026

(54) Optimization-Based GNSS Positioning with Integrated Cycle-Slip Detection

(71) Applicant: Mitsubishi Electric Research Laboratories, Inc., Cambridge, MA (US)

(72) Inventors: Karl Berntorp, Newton, MA (US); Stefano Di Cairano, Newton, MA (US); Yingjie Hu, Mineapolis, MN (US)

(73) Assignee: Mitsubishi Electric Research Laboratories, Inc., Cambridge, MA (US)

(21) Appl. No.: 19/053,594

(22) Filed: Feb. 14, 2025

(51) Int. Cl. G01S 19/23; G01S 19/22; G01S 19/37; G01S 19/39; G01S 19/44

(52) U.S. Cl. CPC G01S 19/23; G01S 19/22; G01S 19/37; G01S 19/393; G01S 19/44

(57) ABSTRACT

A system for probabilistically tracking the state of a receiver of a global navigational satellite system (GNSS) is disclosed. The system includes a processor and a memory storing instructions that, when executed, enable the system to receive GNSS measurement data from a plurality of satellites, including carrier-phase signals and code signals. The system processes the measurement data to detect irregularities, such as cycle slips or multipath effects, and utilizes an adaptive probabilistic estimator to track the state of the receiver. The estimator iteratively predicts the state of the receiver using a state evolution model subject to process noise and updates the predicted state using a measurement model subject to measurement noise. The process noise is dynamically adjusted in response to the detected irregularities, allowing for improved robustness and accuracy in state estimation.

### TECHNOLOGICAL FIELD

This disclosure relates generally to positioning systems, such as the global positioning system (GPS) or the Quasi-Zenith Satellite System (QZSS), and more particularly to the problem of estimating a state of a satellite receiver in real time using batches of data information, where data arrive sequentially in time.

### BACKGROUND

A Global Navigation Satellite System (GNSS) is a system of satellites that can be used for determining the geographic location of a stationary or mobile receiver with respect to the earth. Examples of GNSS include GPS, Galileo, Glonass, QZSS, and BeiDou. Various global navigation satellite (GNS) correction systems are known that are configured for receiving GNSS signal data from the GNSS satellites, for processing these GNSS data, for calculating GNSS corrections from the GNSS data, and for providing these corrections to a receiver, with the purpose of achieving quicker and more accurate calculation of the mobile receiver's geographic position.

Various position estimation methods are known wherein the position calculations are based on repeated measurement of the so-called pseudo-range and carrier phase observables by Earth-based GNSS receivers. The “pseudo-range” or “code” observable represents a difference between the transmit time of a GNSS satellite signal and the local receive time of this satellite signal, and hence includes the geometric distance covered by the satellite's radio signals. The measurement of the alignment between the carrier wave of the received GNSS satellite signal and a copy of such a signal generated inside the receiver provides another source of information for determining the apparent distance between the satellite and the receiver. The corresponding observable is known as the “carrier phase,” which represents the integrated value of the Doppler frequency due to the relative motion of the transmitting satellite and the receiver.

Any pseudo-range observation comprises inevitable error contributions, among which are receiver and transmitter clock errors, as well as additional delays caused by the nonzero refractivity of the atmosphere, instrumental delays, multipath effects, and detector noise. Any carrier-phase observation additionally comprises an unknown integer number of signal cycles, that is, an integer number of wavelengths, that have elapsed before a lock-in to this signal alignment has been obtained. This number is known as the “carrier-phase ambiguity.” Usually, the observables are measured, i.e., sampled, by a receiver at discrete consecutive times. The index for the time at which an observable is measured is referred to as an “epoch.” The known position determination methods commonly involve a dynamic numerical value estimation and correction scheme for the distances and error components, based on measurements for the observables sampled at consecutive epochs.

When GNSS signals are continuously tracked and no loss-of-lock occurs, the integer ambiguities resolved at the beginning of a tracking phase can be kept for the entire GNSS positioning span. The GNSS satellite signals, however, may be occasionally attenuated (e.g., due to buildings in “urban canyon” environments), or momentarily blocked (e.g., when the receiver passes under a bridge or through a tunnel). In such cases, the integer ambiguity values resulting from the signal processing in a delay-locked loop (DLL) are lost and must be redetermined. This process can take from a few seconds to several minutes. In fact, the presence of significant multi-path errors or unmodeled systematic biases in one or more measurements of either pseudo-range or carrier phase may make it difficult with present commercial positioning systems to resolve the ambiguities. As the receiver separation (i.e., the distance between a reference receiver and a mobile receiver whose position is being determined) increases, distance-dependent biases (e.g., orbit errors and ionospheric and tropospheric effects) grow, and, consequently, reliable ambiguity resolution (or reinitialization) becomes an even greater challenge. Furthermore, loss-of-lock can also occur in the DLLs due to a discontinuity in a receiver's continuous phase lock on a signal, which is referred to as a cycle slip. For instance, cycle slips can be caused by a power loss, a failure of the receiver software, or a malfunctioning satellite oscillator. In addition, cycle slips can be caused by changing ionospheric conditions.

GNSS enhancement refers to techniques used to improve the accuracy of positioning information provided by the Global Positioning System or other global navigation satellite systems in general, a network of satellites used for navigation. For example, some methods use measurement differencing techniques based on taking the differences of signals from various satellites, differencing between receivers, differencing between epochs, and combination thereof. Single and double differences between satellites and the receivers reduce the error sources but do not eliminate them.

In some applications, multiple frequency bands are used. In the GPS constellation, this includes carrier frequencies of 1575.42 MHz (the L1 band), 1227.6 MHz (the L2 band), and 1176 MHz (the L5 band). Analogous to the differencing operations, the underlying radio physics can be used to combine several observations on multiple frequency bands to form ionosphere-free combinations, further reducing the impact of ionospheric modeling errors on the position estimates.

Despite these modeling approaches, there is a need to increase the accuracy of GNSS positioning beyond what such conventional methods are capable of. To address this problem of positioning, some approaches cast the positioning problem in a batch setting, where data are received either sequentially or in batches and where the estimate at any given time can be computed not only from the current measurements, but also the past measurements in the stored batch of data. This differs from the filtering approaches, such as Kalman filters, in which the current estimate is based on past and present data and computed in real time epoch per epoch by incorporating the latest measurement. The advantage of a batch solution is that it improves performance when compared to a filtering solution, at an increased computational cost. Such batch solutions are often posed in a factor-graph optimization (FGO) framework, but smoothing solutions such as Fraser-Potter (FP) or Rauch-Tung-Striebel (RTS) frameworks in a Kalman smoothing setting also exist.

Batch processing is the problem of estimating an unknown state trajectory considered over multiple time steps using past, present, and possibly future measurements. This is possible in a post-processing scenario, where a batch of measurements have been taken and are used as input to the algorithm. A smoother is an algorithm that implements a solution to this problem, typically based on Bayesian techniques. For example, many types of Kalman smoothers use estimation models that include a prediction model subject to process noise and a measurement model subject to measurement noise.

In a real-time setting, batch processing considers past and present measurements to determine an estimate of the state at the current time. However, these algorithms rely on well-defined estimation models, and any error in the estimation model or its parameters will cause performance degradations. Smoothers assume that at least a subset of the parameters of the estimation model are known a priori, which is not always the case. Hence, there is a need for methods that adapt the estimation model in a safe manner while simultaneously estimating the states of the receiver (biases, position, velocity, etc.).

Another complication with batch processing is the computational considerations. Indeed, as the batch of data accumulate and the number of measurements are large, the scaling of the estimation problem becomes prohibitive, and the batch of data needs to be capped at some maximum length depending on the available computational budget.

Hence, there is a need for GNSS batch processing that adapts the parameters of the model while reducing the computational load for real-time GNSS estimation.

### SUMMARY

Tracking the state of a GNSS receiver has often relied on processing individual measurements in real-time, where each new signal is used to update the receiver's position or trajectory. While this approach can be effective, real-world signals are sometimes affected by disturbances like cycle slips or multipath effects, which cause irregularities on the data provided to the receiver often resulting in a reduction in the accuracy of the estimation. These irregularities introduce unexpected and sudden changes in the data, making it harder to obtain a smooth prediction of the receiver's state. In such cases, the estimator may struggle to adjust to the changing data quality, resulting in inconsistencies in the receiver's state over time.

To improve the reliability of state estimation, a batch-based approach processes a set of measurements collected over a sequence of time. By working with a group of measurements rather than one at a time, the system can better detect patterns and identify irregularities in the data. For instance, unexpected discrepancies caused by cycle slips or reflections, the so called multipath, can be recognized and handled more effectively. This method allows for the dynamic adjustment of the process noise parameters, so the system can respond to these irregularities without completely ignoring the affected data. The result is a smoother and more adaptive way of tracking the receiver's state.

A benefit of batch tracking is that it helps maintain continuity in the data. This continuity is important for estimating a receiver's trajectory over time that is smooth. If irregular data points are removed, or “cleaned,” before processing, it can unintentionally break this flow. Gaps or missing information can disconnect the trajectory, making it harder to track the receiver's movement in a consistent way. While removing problematic data may seem like a solution, it may cause the loss of valuable context that helps the system understand changes in the receiver's state.

By preserving all measurements within a batch, the system can adaptively account for irregularities while maintaining the natural flow of data. Instead of discarding affected signals, the system adjusts its noise parameters to reduce their impact. This approach allows the estimator to make use of all available information while ensuring that the receiver's trajectory remains smooth and reliable. In this way, the system strikes a balance between handling measurement challenges and preserving data continuity, leading to more accurate and dependable tracking results.

To that end, some embodiments disclose an adaptive probabilistic estimator configured for iteratively predicting the state of the GNSS receiver using a state estimation model of the receiver subject to process noise and updating the state of the receiver using a measurement model processing the GNSS measurement data subject to measurement noise. In addition or alternative to data cleaning, the adaptive probabilistic estimator is configured to vary the process noise in response to detecting the irregularities in the GNSS measurement data. Such an adaptive probabilistic estimator is advantageous for real-time GNSS state estimation as well as for batch processing of the GNSS measurement data.

For example, Factor Graph Optimization (FGO) is a method that can be beneficially applied to navigation using the GNSS measurement data. FGO is an optimization framework based on factor graphs that model relationships between variables through “factors” to solve large-scale estimation problems efficiently. However, for precise results, FGO methods need to rely on high-quality measurements and data. Issues like cycle slips or multipath errors degrade the data quality and can compromise the accuracy of the optimization. It is an object of some embodiments to mitigate these drawbacks while preserving the advantages of the FGO methods.

Some embodiments are based on a recognition that batch estimators such as FGOs can generate more accurate predictions of the state variables than filters, as FGOs include past and present measurements simultaneously and can more accurately describe the spatial distribution of the variables of interest. To that end, it is an object of some embodiments to track the state of the GNSS receiver using techniques implemented using FGO.

Some embodiments are based on the recognition that FGO methods commonly need a batch of data clean of cycle slips or multipath. However, such sets of data often require a costly and heuristic pre-processing step to determine whether a measurement at a given time stamp is clean or not. Consequently, some embodiments incorporate adaptive priors of the integer ambiguity, such that the FGO can adaptively determine how much importance each measurement in the optimization has.

Some embodiments realize that determining the state of the receiver jointly with the integer ambiguity in FGO is a highly complex mixed-integer optimization problem that is prohibitive to solve in real time, if at all. However, computational tractability can be achieved by decomposing the problem. Consequently, some embodiments solve the mixed-integer optimization problem in a two-step optimization procedure

Other embodiments are based on the understanding that even with a two-step optimization procedure, the batch length needs to be capped due to computational load. Consequently, it is an object of some embodiments to disclose a method for reducing complexity of the estimation procedure used for ambiguity resolution.

The measurements of different combination of satellites can be represented as a measurement matrix. Each element of a matrix is a single or double differenced measurement of at least one unique pair of satellites and/or receivers. Different satellites and/or receivers can be grouped in different pairs to increase dimensionality of the measurement matrix. Each measurement carries information that can be used for position estimation. To that end, it can be possible to use the measurement matrix in its entirety for position estimation. However, in some situations, the dimensionality of the measurement matrix caused by availability of line-of-sight (LOS) satellites for the tracked GNSS receiver prohibitively increases computational complexity of position estimation filters.

Some embodiments are based on recognition that only a portion of all available measurements from measurement matrix can be used in state estimators. Typically, measurements from at least four LOS satellites are needed for accurate position estimation. Because the measurement matrix includes measurements representing a pair of satellites, at least two elements of the measurement matrix are needed for position estimation. To that end, it is possible that any two elements of the matrix can be selected. Such a selection can be random or following some selection principle. Examples of such a principle include selecting randomly a single satellite and collecting a predetermined number of measurements of differences between the selected satellite and other LOS satellites. However, such an approach can be suboptimal from an information quality point of view.

Some embodiments are based on recognition that different elements of measurement matrix can have different informational value to the position estimation filter. As an illustrative example, a pair of satellite positions on the same LOS with respect to the GNSS receiver has less informative value than a pair of satellites positioned on different LOS. This is because they provide the same geometric information of the receiver.

Accordingly, different measurements in the measurement matrix carry different amount of information about position of the GNSS receiver. Some embodiments are based on realization that it is possible to select a predetermined number of measurements with maximum total information about the position. Because the number of selected measurements is predetermined from computational point of view, but the measurements are selected from available measurements based on informative value point of view, the selected combination improves the accuracy of position estimation without sacrificing its performance.

For example, some embodiments utilize the Fisher information matrix to project the acquired measurements into a lower-dimensional subspace, formulating an optimization program to find the projected measurement that minimally degrades filter performance with respect to the mean squared error (MSE) of the estimate. Using the projected measurements achieves a significant computational speedup while retaining the performance of the original filter.

Another embodiment is based on the understanding that from an algorithmic standpoint, the combination of satellites does not have to include full satellites. For instance, consider the case of having four satellites. Then, it may be better to use a fourth of the measurement of the first satellite and three fourths of the fourth satellites, than to combine full satellite measurements. In other words, the combination of satellite measurements forming a measurement is a noninteger combination of satellites. Intuitively, this is because the Fisher information captures the uncertainty in the system, and although a combination of full satellites has highest probability, since there is some uncertainty about the correctness of such combination, it is safer from an MSE standpoint to choose noninteger combinations.

### BRIEF DESCRIPTION OF THE DRAWINGS

FIG. 1A illustrates the geometry of a Global Satellite Navigation System (GNSS) according to some embodiments.

FIG. 1B illustrates a scenario with an intersection where a base station is included in the GNSS positioning to accurately reconstruct the trajectories of the vehicles in the intersection.

FIG. 1C depicts a scenario relating to environmental monitoring.

FIG. 1D shows a schematic of the Kalman filter (KF) used by GNSS estimation methods.

FIG. 1E shows a schematic of the information flow in an FGO.

FIG. 1F describes a scenario where multi-path is induced in a GNSS measurement due to a reflection in a building.

FIG. 1G shows a block diagram of a method for probabilistically tracking a state of a receiver of a global navigational satellite system (GNSS) employing principles of an embodiment.

FIG. 2A shows a block diagram of a system for the tracking of a state of a GNSS receiver

FIG. 2B shows a block diagram of a receiver used by some embodiments.

FIG. 3A shows a way in which state of the art FGO for GNSS is implemented

FIG. 3B shows an illustration of the FGO employed by some embodiments.

FIG. 3C illustrates how a measurement model is synthesized in one embodiment of the disclosure.

FIG. 3D illustrates a variable basis, mixed-integer estimation model.

FIG. 3E details one embodiment of the cycle slip detection

FIG. 3F illustrates the probability density function of the integer jump noise

FIG. 4A shows that the measurements of different combinations of satellites can be represented as the matrix

FIG. 4B shows a schematic illustrating a recognition of different embodiments that different measurements forming the measurement matrix can carry different amount of information.

FIG. 4C shows a measurement matrix to be used in estimation.

FIG. 4D illustrates the result from an optimization procedure for minimizing the loss of information of a subset of measurements with respect to the set of measurements according to one embodiment.

FIG. 5A shows a flowchart of a method for selecting the subset of measurements according to one embodiment

FIG. 5B shows an implementation of a method for the determining a reduced an FIM according to one embodiment

FIG. 5C shows a flowchart of a method for determining the projection operator to produce the subset of measurements according to some embodiments.

FIG. 5D shows a flowchart of a method for optimizing the CRB finding the optimal projection operator.

FIG. 5E shows a schematic of fractional measurement representations according to some embodiments.

FIG. 6A shows a flowchart of one iteration of a method for FGO-based positioning using measurement reduction.

FIG. 6B shows a flowchart of one iteration of a method for FGO-based positioning using measurement reduction.

FIG. 7A shows a block diagram of a system for joint tracking and/or control of receivers

FIG. 8A shows a schematic of a vehicle controlled directly or indirectly according to some embodiments.

FIG. 8B shows a schematic of interaction between the controller receiving controlled commands from the system and the controller of the vehicle according to some embodiments.

### DETAILED DESCRIPTION

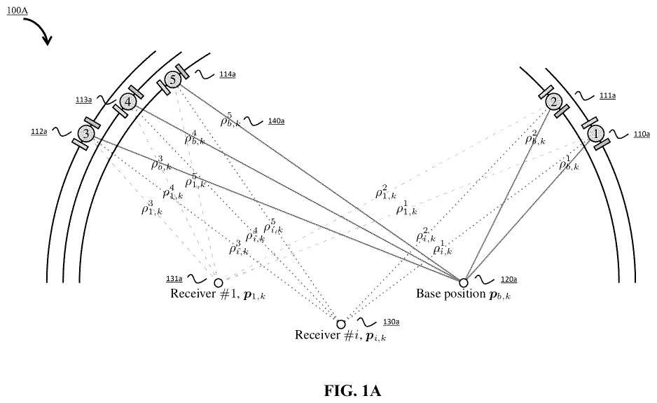

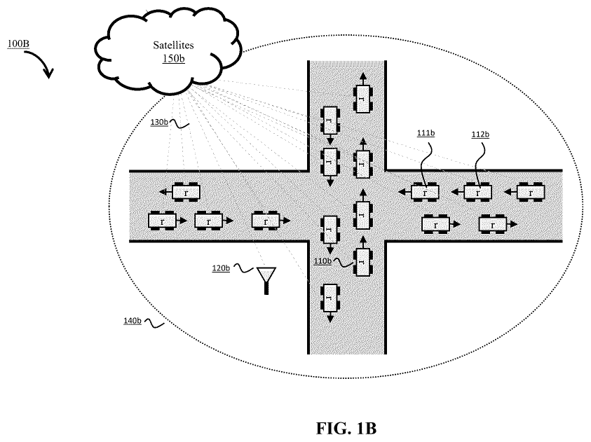

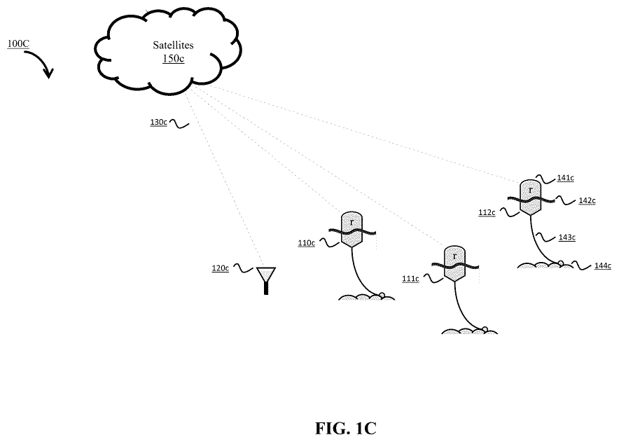

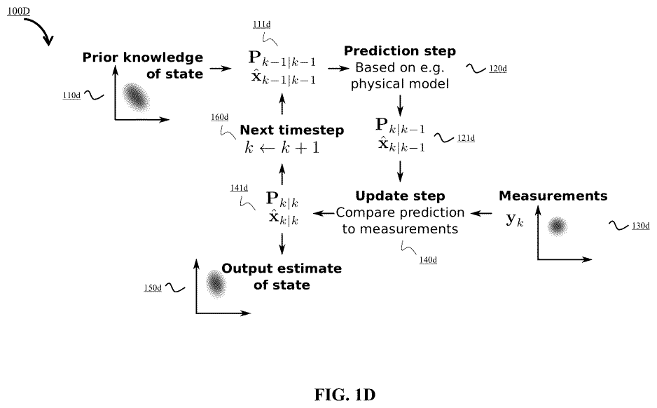

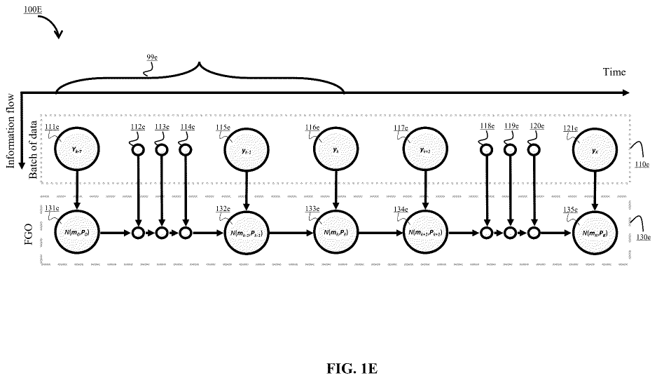

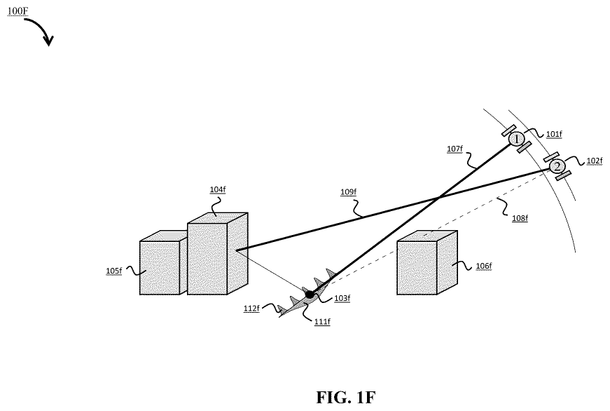

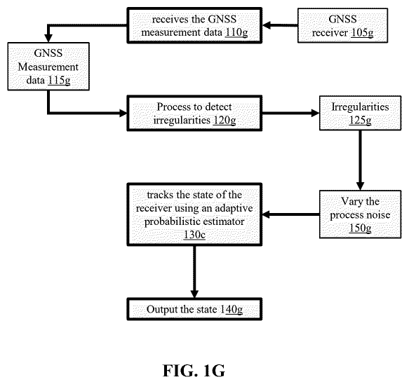

FIG. 1A illustrates the geometry of a Global Satellite Navigation System (GNSS) according to some embodiments. The receivers 130a and 131a receive radio signals that are processed in the GNSS receiver to yield pseudo-range, carrier-phase and Doppler measurements, along with other signals indicative of the quality of the radio communication. These measurements relate to the geometric range in 140a and its time derivative by a set of biases. In some embodiments, the measurements taken in receivers 130a and 131a are combined with measurements taken by a known base station at 120a to attenuate sources of error. One such set of pseudo-range, carrier-phase and Doppler measurements are received per satellite seen by the receiver on each epoch and processed locally in the receiver. In FIG. 1A, the set of visible satellites is illustrated 110a-114a, but some embodiments utilize a much larger number of satellites from many different constellations, including, but not limited to, the GPS, Galileo, Glonass, QZSS, and BeiDou constellations. Some embodiments use one or multiple carrier frequency bands per satellite.

In various embodiments, the GNSS receivers 120a, 130a, and 131a may differ. For example, in the embodiment depicted in FIG. 1A, receiver 120a is a base receiver, whose position is known and can be mounted on the ground. In contrast, receivers 130a and 131a can be either mobile and assumed to be in motion or stationary receivers, but in either case, their positions are unknown. For instance, the receivers 130a and 131a can be mounted in a cell phone, a car, or a tablet. In all described embodiments, there are multiple GNSS receivers receiving code and carrier phase signals, and the number of receivers is large. In some embodiments, the base station 120a is moving, and in yet other embodiments, the base station does not have a known position.

FIG. 1B illustrates a scenario with an intersection where a base station 120b is included in the GNSS positioning to accurately reconstruct the trajectories of the vehicles in the intersection. In some embodiments, the base station is a part of a roadside unit (RSU) which may optionally be used to control the intersection. In this example, several GNSS receivers are attached to vehicles 110b in a four-way crossing, and the base station 120b is located nearby, and the vehicles' positions are estimated in a region near the intersection 140b. Due to the proximity of the receivers, and the use of the same base station 120b and same set of satellites 150b, there exist correlations between the measurements, which gives rise to correlated state estimates and disturbances. As such, it is possible that multipath detected in one satellite signal from the vehicle 111b may increase the likelihood that the vehicle 112b will experience similar disturbances a short while later when in the approximate position of 111b. This is due to multipath being in part a geometric phenomenon, which depends on the relative location of the receiver and satellite and any obstructing building or trees that appear between the receiver and satellite.

FIG. 1C depicts a scenario relating to environmental monitoring, where the positions of a set of aquatic surface buoys 110c, 111c, 112c are to be estimated. The buoys are equipped with antenna 141c which is above the water level 142c, and in some embodiments, the buoys are attached to the ocean floor 144c with a mooring chain 143c. In the example, there is a base station 120c which communicates with the satellites 150c using radio communication 130c.

In some embodiments, these buoys 110c, 111c, 112c are placed in water reservoirs and lakes, and in other embodiments, the buoys 110c, 111c, 112c are placed in the ocean. In the former case, the buoys monitor changes in water levels over long time scales, where sudden changes due to rain or irrigation events imply that the dynamics of the buoy may differ in time. In the case of monitoring of land-based reservoirs, reflections in trees and the water may give rise to extended periods of multi-path disturbance. In the case of oceanic monitoring, the waves may give rise to unpredictable reflections which can cause multipath effects even when there is a clear line of sight between the antenna and the satellite.

FIG. 1D shows a schematic of the Kalman filter (KF) having principles employed by some embodiments using GNSS estimation methods. The KF is a tool for state estimation in linear state-space models,

$${x}_{k + 1} = {A}_{k} {x}_{k} + {q}_{k}$$

$${y}_{k} = {C}_{k} {x}_{k} + {r}_{k}$$

where

$${q}_{k} ∼ N ( 0 , {Q}_{k} )$$

$${r}_{k} ∼ N ( 0 , {R}_{k} )$$

and it is the optimal estimator when the noise sources are known and Gaussian, in which case also the state estimate is Gaussian distributed. The KF estimates the mean and variance of the Gaussian distribution because these are the two required quantities, sufficient statistics, to describe the Gaussian distribution.

The KF starts with an initial knowledge 110d, of the state, to determine a mean of the state and its variance 111d. The KF then predicts 120d the state and the variance to the next time step, using a model of the system, to obtain an updated mean and variance 121d of the state. The KF then uses a measurement 130d in an update step 140d using the measurement model of the system, to determine an updated mean and variance 141d of the state. An output 150d is then obtained, and the procedure is repeated for the next time step 160d. The update equations of the linear KF given the above estimation model is as follows

$${m}_{k \vert k - 1} = {A}_{k - 1} {m}_{k - 1}$$

$${P}_{k \vert k - 1} = {A}_{k - 1} {{P}_{k - 1} ( {A}_{k - 1} )}^{T} + {Q}_{k}$$

$${K}_{k} = {{P}_{k \vert k - 1} ( {C}_{k} )}^{T} {( {C}_{k} {{P}_{k \vert k - 1} ( {C}_{k} )}^{T} + {R}_{k} )}^{- 1}$$

$${m}_{k} = {m}_{k \vert k - 1} + {K}_{k} ( {y}_{k} - {C}_{k} {m}_{k \vert k - 1} )$$

$${P}_{k} = ( I - {K}_{k} {C}_{k} ) {P}_{k \vert k - 1}$$

where the filter posterior at a time k is

$$p ( {x}_{k} \vert {y}_{0 : k} ) = N ( {x}_{k} ; {m}_{k} , {P}_{k} )$$

In contrast to the Kalman filter, batch estimators, such as factor graph optimization (FGO), use a batch of data and a set of factors in an optimization framework. Batch estimators like FGOs optimize all available measurements at once to estimate the most likely values for variables in a system, using a factor graph representation.

For example, the FGOs use a factor graph, which is a bipartite graph that includes two types of nodes: variable nodes (representing unknown quantities to be estimated, such as positions) and factor nodes (representing constraints or measurements related to these variables). In a batch setting, FGOs collect all data points or measurements, then solve for the variables that minimize the overall error in the graph. This can be done using non-linear optimization techniques like Gauss-Newton or Levenberg-Marquardt, making them computationally intensive but very accurate as they leverage all the information at once. In such a manner, FGOs aim to find a globally consistent solution by treating all measurements together, unlike online (incremental) estimators that only process data sequentially. By doing this, they tend to be more accurate since they consider all available constraints, allowing for more robust handling of complex, loop-closing problems.

FIG. 1E shows a schematic of the information flow in an FGO 130e, run on a batch of data 110e of a sliding window 99e of length T time steps containing several measurements 111e, 112e, 113e, 114e, 115e, 116e, 117e, 118e, 119e, 120e, 121e. It is recognized that under a linear Gaussian and unconstrained system, the FGO is identical, i.e., it gives the same state estimate as a Kalman filter. However, for nonlinear and/or constrained systems, FGO outperforms Kalman filters.

The FGO solves the optimization problem

$$\hat{X} = arg max \text{?} P ( X \vert Y )$$

$$\text{?} \text{indicates text missing or illegible when filed}$$

That is, it finds the state estimate of X that maximizes the probability of the state based on the measurement batch Y. Some embodiments formulate this optimization problem by means of factors over a sliding window of length T, resulting in the optimization problem

$$\hat{X} = {arg max}_{X} P ( X \vert Y ) = {arg max}_{X} {\sum }_{i = 1}^{T} {‖ {y}_{pi} - h ( {x}_{i} ) ‖}^{2} \text{?} + {‖ {y}_{ϕ i} - h ( {x}_{i} ) - λ {n}_{i} ‖}^{2} \text{?} + {‖ {x}_{i} - f ( {x}_{i - 1} ) ‖}_{{Q}_{x}}^{2} + {‖ {n}_{i} - {n}_{i - 1} ‖}_{{Q}_{x}}^{2}$$

$$\text{?} \text{indicates text missing or illegible when filed}$$

Which is a weighted combination of the pseudo-range factor, a carrier-phase factor, a motion model factor, and an ambiguity factor, whose details are explained by other embodiments of the disclosure.

It is recognized that some relationships in the estimation model, such as the geometric ranges, are nonlinear functions of the state (position, velocity, biases) of the receiver. In this case, the measurement model is nonlinear. In this case, some embodiments leverage gradients of the nonlinearities to find the optimal solution.

In some embodiments, the state estimator uses the carrier phase single difference (SD) and/or double difference (DD) for estimating a state of the receiver, wherein the state includes a position of the receiver. When a carrier signal transmitted from one satellite is received by two receivers the difference between the first carrier phase and the second carrier phase is referred as the single difference (SD) in carrier phase. Alternatively, the SD can be defined as the difference between signals from two satellites reaching a receiver, wherein the first satellite is called the base satellite. For example, the difference between signal from satellite 110a and signal from satellite 111a is one SD signal, where satellite 110a is the base satellite. Using pairs of receivers, 120a and 130a in FIG. 1A, the difference between SDs in carrier phase obtained from the radio signals from the two satellites is called the double difference (DD) in carrier phase. When the carrier phase difference is converted into the number of wave lengths, for example, λ₁≈0.1905 m for L1 GPS (and/or GNSS) signal, it is separated by fractional and integer parts. The fractional part can be measured by the positioning apparatus, whereas the positioning device is not able to measure the integer part directly. Thus, the integer part is referred to as integer bias or integer ambiguity.

In other embodiments, it is recognized that combining measurements on different frequency bands can be done in such a way as to eliminate certain biases from the estimation problem. One such example is ionosphere-free (IF) multi-band (MB) combinations, in which undifferenced, single differenced, or double differenced measurements are taken in a linear combination over at least two different frequency bands, using a fraction of each proportional to the ratio of the carrier frequencies squared. It is recognized that this, if done appropriately, eliminates the ionospheric delays from the estimation problem.

In general, a GNSS can use multiple constellations at the same time to determine the receiver state. For example, GPS, Galileo, Glonass, and QZSS can be used concurrently. Satellite systems typically transmit information at up to three different frequency bands, and for each frequency band, each satellite transmits a code measurement and a carrier-phase measurement. These measurements can be combined as either single differenced or double differenced, wherein a single difference includes taking the difference between a reference satellite and other satellites, and wherein double differencing includes differencing also between the receiver of interest and a base receiver with known static location.

FIG. 1F describes a scenario where multi-path is induced in a GNSS measurement due to a reflection in a building, resulting in modeling errors which worsens the estimates of the position of the receiver. In this example, a receiver 103f is communicating with two satellites 101f, 102f, registering pseudo-range 111f and carrier phase 112f measurements. The measurement likelihoods of these signals 111f and 112f are depicted, and it is understood that the pseudo-range measurement likelihood is associated with a larger variance of signal 111f, while the carrier-phase measurement likelihood has several modes separated by a multiple of the carrier wavelength associated with the GNSS communication. For example, in the GPS constellation, the carrier wavelength on the L1 band is approximately 19.05 cm. The example contains three buildings 104f, 105f, 106f, and the signals from satellite 102f is reflected in the building 104f. Thus, the receiver is expecting the measurement to correspond to the line-of-sight distances 107f, 108f, but the actual distance 109f measured from satellite 102f is much longer, due to the reflection. This modeling error causes significant positioning errors when computing the location of the position based on the GNSS measurement information, and it is an objective of the disclosure to detect when such modeling errors are present.

FIG. 1G shows a block diagram of a method for probabilistically tracking a state of a receiver of a global navigational satellite system (GNSS) employing principles of an embodiment. The method can be performed by a tracking system operatively connected to the GNSS receiver 105g. The tracking system includes a processor; and a memory having instructions stored thereon that, when executed by the processor, cause the system to perform the steps of the embodiment.

The embodiment receives 110g the GNSS measurement data 115g transmitted from a plurality of satellites, including carrier phases and code signals, and processes 120g the GNSS measurement data 115g to detect irregularities 125g.

The embodiment tracks 130g the state of the receiver using an adaptive probabilistic estimator iteratively predicting the state of the receiver using a state estimation model of the receiver subject to process noise and updating the state of the receiver using a measurement model processing the GNSS measurement data subject to measurement noise, and outputs 140G the tracked state of the receiver The adaptive probabilistic estimator is configured to vary 150g the process noise in response to detecting the irregularities in the GNSS measurement data. Doing in such a manner preserve continuity of the measurement data as contrasted with data cleaning approach described below.

In some embodiments, the prediction model forming the motion model and ambiguity factors is linear or nonlinear, with some states configured on the real numbers, and others, specifically biases relating to the integer ambiguities configured on the integers. In such a case, the noise driving the prediction model is partitioned into gaussian noise q for the real-valued states, and integer jump noise s for the integer valued states

$$\begin{matrix}{x}_{k + 1} = {A}_{k} {x}_{k} + {B}_{k}^{ℝ} {q}_{k} + {B}_{k}^{ℤ} {s}_{k} , \\ {y}_{k} = {h}_{k} ( {x}_{k} ) + {C}_{k} {x}_{k} + {r}_{k} ,\end{matrix}$$

where two different models can be defined. The first is the relaxed estimation model, in which the biases related to the ambiguities are permitted to take values on the real numbers (hence relaxed), and the other is a fixed estimation model, where specific fixed ambiguity biases are assumed, and the number of states x in the estimation model is reduced to only contain the real-valued states. In the FGO, it is recognized that solutions need to be computed for each of these models. The relaxed model to find the integer ambiguities, and the fixed model to compute the receiver positioning estimates given these integer biases.

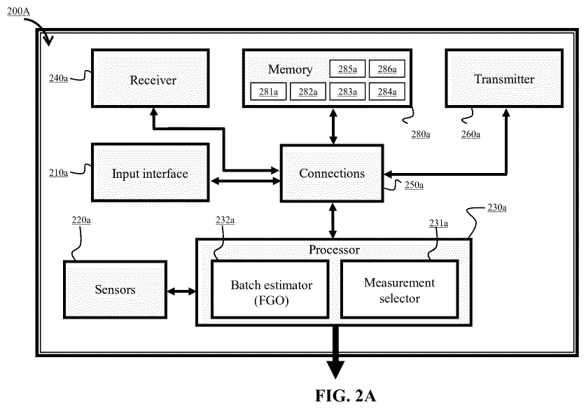

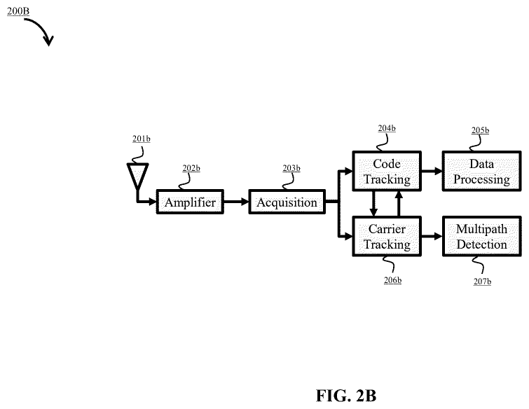

FIG. 2A shows a block diagram of a system 200a for the tracking of a state of a GNSS receiver according to some embodiments. The estimation system 200a includes an input interface 210a to accept motion data indicative of a change of a state of the receiver and measurements of satellite signals, i.e., carrier signals, code signals and Doppler signals, computed from the radio transmissions from a set of GNSS satellites. Each carrier signal includes a carrier phase ambiguity as an unknown integer number of wavelengths of the carrier signal traveled between the satellite and the receiver, wherein a measurement for each satellite signal includes a single difference between the satellite signal transmitted by a satellite and another satellite signal to include a relative position of the receiver of the satellite signal with respect to a position of the satellite subject to integer ambiguity of the carrier signal of the satellite and noise, such that all possible measurements for each satellite signal form a set of measurements. The system 200a can be implemented internally on several devices on which the receiver 240a is located, such as handheld devices, cars, airplanes, or trains. Additionally, or alternatively, the system 200a can be communicatively connected to the device, i.e., the receiver 240a is not physically inside the system.

The system also includes a memory 280a storing a motion model 281a relating a previous state of the receiver to a current state of the receiver estimated in the first and the second estimator, wherein the motion model is subject to process noise, and a measurement model 282a relating measurements of the carrier signals, code signals, and Doppler signals received by the receiver 240a to the current state of the receiver using the carrier phase ambiguities of the carrier signals. The measurement model relate a subset of the measurements of satellite signals to the current state of the receiver at different time steps. The maximum size of the subset of measurements is variable and depends on the number of visible satellites at a given time step and the chosen sliding window of the FGO. The measurement model is a probabilistic model subject to measurement noise. Due to the inherent random noise and errors of the satellite transmitter and receiver 240a, the motion model and the measurement model are probabilistic, thus allowing several values of the carrier phase ambiguity at any given epoch to be consistent with those models with different probabilities. The memory 280a can also store 284a set of combinations of integer values described by other embodiments.

The system 200a can include additional sensors 220a that can help in aiding the positioning system. For instance, the sensors 220a can include an inertial measurement unit (IMU), a camera, wheel encoders if mounted in a wheeled vehicle, one or more laser ranging sensors, radar sensors and barometers. For example, when connected to a car, the IMU and wheel encoders can be used in a motion model of the vehicle to increase accuracy of the positioning system beyond what otherwise would be possible.

The system 200a includes a processor 230a for tracking the state of the receiver using a set of instructions stored in memory 285a forming an FGO. Further, the processor 230a is configured to select 231a a subset of measurements with respect to the set of measurements using measurement reduction methods described by other embodiments of the disclosure. Also, the processor 230a is configured to execute the FGO 232a determining states of the receiver 240a by jointly using the motion model 281a and the measurement model 282a. The FGO determines a joint estimate of the state of the receiver 240a and the ambiguity with respect to the motion model 281a and the measurement model 282a and can be executed by the processor 230a concurrently and/or sequentially.

The IMU can include 3-axis accelerometer(s), 3-axis gyroscope(s), and/or magnetometer(s). The IMU can provide velocity, orientation, and/or other position related information to the processor 230a. In some embodiments, the IMU can output measured information in synchronization with the capture of each image frame from a camera. In some embodiments, the output of the IMU is used in part by the processor 230a to fuse the sensor measurements and/or to further process the fused measurements.

The system 200a can include a transmitter 260a enabled to transmit one or more signals. For instance, the transmitter 260a can send the state of the receiver 240a to other estimation methods, to be used in fusion with other sensors to improve accuracy. The receiver 240a and transmitter 260a can receive and transmit over one or more types of wireless communication networks. The receiver 240a and transmitter 260a can permit communication with wireless networks based on a variety of technologies such as, but not limited to, femtocells, Wi-Fi networks or Wireless Local Area Networks (WLANs), which may be based on the IEEE 802.11 family of standards, Wireless Personal Area Networks (WPANS) such Bluetooth, Near Field Communication (NFC), networks based on the IEEE 802.15x family of standards, and/or Wireless Wide Area Networks (WWANs) such as LTE, WiMAX, etc. The system 200a can also include one or more ports for communicating over wired networks, such as the controller area network (CAN) bus.

The memory 280a can store 286a carrier phase measurements, code measurements, Doppler measurements, and other signals related to the GNSS signal processing such as SNR, CN, and satellite elevations, as well as data provided by the sensors 220a. For example, in some implementations, the memory 280a stores a geometry of the physical construction on which the receiver is mounted 284a, and a geometrical relationship between the satellites and the receivers 283a. In general, the memory 280a can represent any data storage mechanism. The memory 280a can include, for example, a primary memory and/or a secondary memory. The primary memory can include, for example, a random-access memory, read only memory. While illustrated in FIG. 2A as being separate from the processors 230a, all or part of a primary memory can be provided within or otherwise co-located and/or coupled to the processors 230a.

The different components in the system 200a can be operatively coupled to other each other through connections 250a. The connections 250a can comprise buses, lines, fibers, links, or combination thereof.

The processor 230a can be implemented using a combination of hardware, firmware, and software. The processor 230a can represent one or more circuits configurable to perform at least a portion of a computing procedure or process related to sensor fusion and/or methods for further processing the fused measurements. The processor 230a retrieves instructions and/or data from memory 280a. The processor 230a can be implemented using one or more application specific integrated circuits (ASICs), central and/or graphical processing units (CPUs and/or GPUs), digital signal processors (DSPs), digital signal processing devices (DSPDs), programmable logic devices (PLDs), field programmable gate arrays (FPGAs), controllers, micro-controllers, microprocessors, embedded processor cores, electronic devices, other electronic units designed to perform the functions described herein, or a combination thereof.

FIG. 2B shows a block diagram of a receiver used by some embodiments. In those embodiments, the measurements to detect the presence of multipath 207b are natively computed in the receiver as part of the process by which position is estimated. After the antenna 201b, and before acquisition 203b, the received signal is made up of the sum of the signals emitted by each satellite. An amplifier 202b is designed to strengthen the signal for further processing. The acquisition 203b initializes the tracking process by supplying estimates for the phase and frequency of each received satellite signal. The tracking unit is tasked with estimating and providing measurements of the phase and frequency of each satellite signal over time for the carrier wave 206b and for code tracking 204b. The code tracking 204b is used to determine and process 205b the data messages. The carrier wave tracking 206b is used to determine the multipath 207b.

Some GNSS receivers can have several antennae for a single receiver, and combinations of several antennae with as many receivers are conceivable. One embodiment uses multiple antennae with as many receivers as antennae. The antennae are spatially separated, which allows the receivers to detect differences between the observed carrier frequencies on the same satellite signal.

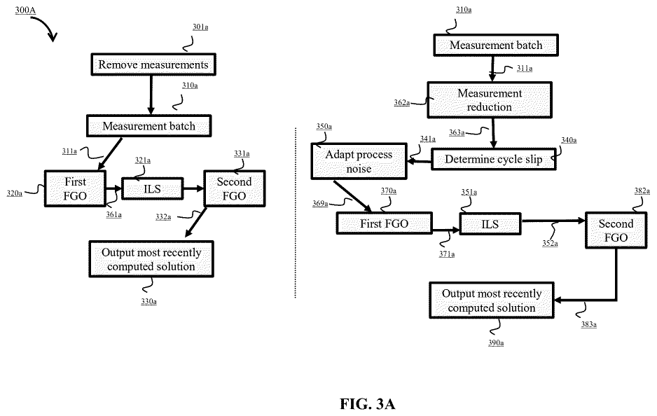

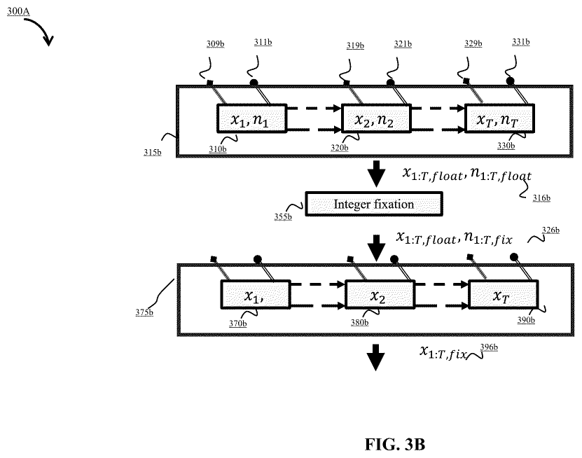

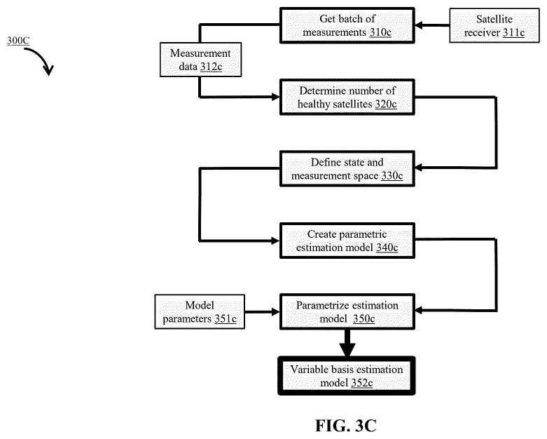

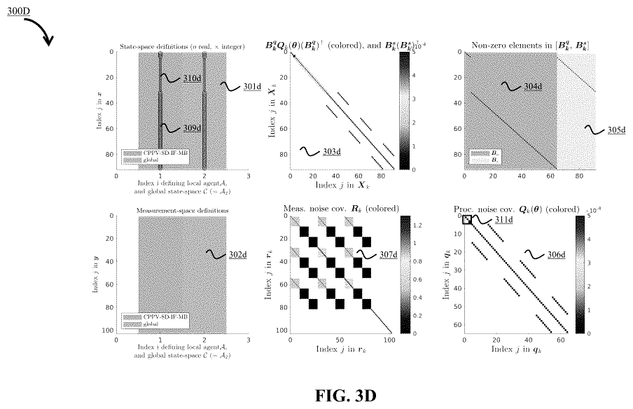

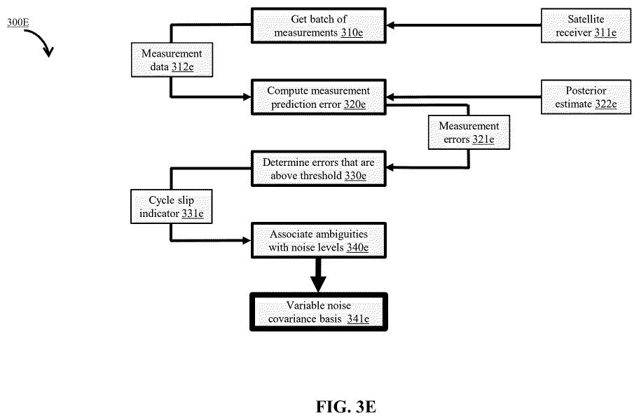

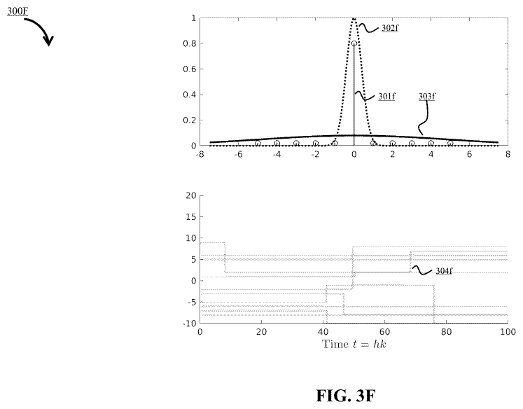

FIG. 3A shows a way in which state of the art FGO for GNSS is implemented, wherein a batch of measurement data 310a consisting of individual measurements 311a are processed by a two-stage FGO 320a, 321a, with fixed process noise models. Here, the first FGO 320a optimizes for real-valued receiver state and real-valued ambiguity. Next, the ambiguities are fixed, e.g., using an integer least squares (ILS) 321a method such as the well-known Lambda method or its variants. Finally, using the fixed ambiguities a second FGO 331a is executed based on the measurement model with fixed ambiguities to produce updated state trajectories 332a, and the most recently computed solution is outputted 330a. Before running FGO, however, measurements that are not deemed suitable are removed 301a

One embodiment of the present disclosure is also illustrated in FIG. 3A and is distinctly different to the conventional approach in the way in which the model parameters are chosen and the best model is selected. Again, a batch of measurement data 310a consisting of individual measurements 311a are used, but without preprocessing. Instead, the measurements are reduced 362a to produce a batch of measurements 363a with reduced dimension, wherein the measurements 363a are determined by other embodiments of the disclosure. Using the reduced measurement batch 363a, one embodiment determines 340a if cycle slip has occurred in the measurement data. Based on the determined cycle slips 341a, the current disclosure adapts 350a the process noise of a random walk of the integer ambiguity process.

For instance, some embodiments are based on the recognition that ambiguities have a jump behavior due to the presence of occasional cycle slips.

Using the adapted process noise 369a of the ambiguity evolution, one embodiment executes a first FGO 370a to determine relaxed state and ambiguity trajectories 371a. This is followed by an ILS 351a to fixate the ambiguities 352a, and a second FGO 382a solves for the state trajectory 383a using the fixed ambiguity and outputs the most recently computed solution 390a.

Some embodiments employ various implementations of FGOs that formulate a maximum a posteriori estimation problem as a nonlinear graph optimization. Each node of the graph represents a system state and edges of the graph are called factors, encoding information of measurements and constraints of the system. By optimally solving the nonlinear optimization, a posteriori estimates of the state trajectory can be determined, which maximizes the posterior probability of the system states conditioned on a batch of measurements and constraints within the graph. Various embodiments employ FGOs in a sliding window, that move across the time axis as new measurements are gathered.

FIG. 3B shows an illustration of the FGO employed by some embodiments. Some embodiments employ carrier phase and pseudo-range factors 309b, 319b, 329b from multiple satellites, as well as other sensor measurements employed as factors 311b, 321b, 331b, e.g., Doppler, accelerometer, gyroscope, camera. The sensor measurements are collected over a batch sliding window of length T, and the receiver state and real-valued ambiguities 310b, 320b, and 330b are determined using an optimization solver 315b (the first FGO) determine the state trajectory and real-valued ambiguities 316b over the batch window. Next, using the float solution of receiver state and ambiguities 316b, some embodiments determine 355b the integer ambiguities. It is recognized that a plethora of different methods can be used for the integer fixation, and fundamentally an integer least squares solution is found, e.g., by well-known tools such as Lambda, M-Lambda, and the like. Next, with the fixed integer ambiguity and the float solution of the receiver state 326b, a second FGO 375b executes using sensor measurements over the batch sliding window of length T, and the receiver state 370b, 380b, and 390b are determined using an optimization solver given the fixed ambiguities from the float solution of the receiver state 326b, resulting in the estimated states 396b.

FIG. 3C illustrates how a measurement model is synthesized in one embodiment of the disclosure. The synthesis starts by acquiring a batch of satellite measurements 310c from one or more satellite receivers 311c. As described in relation to FIG. 1A, these measurements may include signals indicative of pseudo-range, carrier phase and/or Doppler measurements, from multiple GNSS constellation on multiple frequency bands. The measurements may also include other sensory information, as relayed in association with FIG. 2A.

Based on the measurement data, the satellite signals are flagged as healthy or unhealthy 320c, depending on factors such as carrier-noise density ratios, elevation angles, the geometry of the open sky, or more refined estimation algorithms. Based on the satellite availability, the state and measurement spaces are defined. In some embodiments, the union of healthy and visible satellites across all time steps or epochs in a measurement batch are used to determine the size of the state and measurement spaces, subject to the selected differencing scheme. As indicated in relation to FIG. 1A, this measurement scheme may include undifferenced, SD, DD, and ionosphere-free combinations of the GNSS observables.

It is recognized that the choice of measurement scheme affects both the definition of the state space and the definition of the measurement space. It is further recognized that the number of states in the estimation model may vary in time, as satellites turn from a healthy status to unhealthy and vice versa. In such an event, the estimation model may adapt the process noise on the states that are not observable in the local information and adjust the measurement model accordingly. Once the functional relationships in the estimation model have been determined in 340c, the model is parametrized 350c based on a set of model parameters 351c.

This estimation model may have a fixed parameter dependence but may also be defined in a variable basis form. For instance, the variance in the process noise associated with the integer ambiguity biases may not be known, but it may be known that it can take one of two values as defined by the model parameters. The estimation model, before the cycle slip detection, is called a variable basis model 352c. It is the object of the adaptive process noise determination to not only determine the best parameters, but also fix the basis and the parameter dependence in the estimation model.

FIG. 3D illustrates what such a variable basis, mixed-integer estimation model may look like in the context of double differenced (DD) measurements subject to ionosphere-free (IF) combinations on multiple frequency bands using only the GPS constellation. In this case, there are about 100 states 301d. The real-valued 309d include the kinematic states of the receiver (for example position and velocity), as well as DD-IF biases relating to the ionospheric delays and tropospheric delays. The integer-valued states 310d model the integer ambiguity biases. Similarly, the measurement space is illustrated in 302d, and all measurements are configured on the real numbers. All of the states are combined in x and all the measurements are combined in y, and both are in this example governed by a dynamical system

$$\begin{matrix}{x}_{k + 1} = {A}_{k} {x}_{k} + {B}_{k}^{ℝ} {q}_{k} + {B}_{k}^{ℤ} {s}_{k} , \\ {y}_{k} = {h}_{k} ( {x}_{k} ) + {C}_{k} {x}_{k} + {r}_{k} ,\end{matrix}$$

The full process noise covariance matrix 303d is in this example estimation model parameterized in the model parameters θ, and has a very particular structure arising from the differential relationships assumed between the states in this particular estimation model. For instance, that velocities are the time derivatives of positions, and that a change in position has no bearing on time delays experience when a signal passes though the troposphere. Here, the crosses correspond to the integer random walks associated with the integer ambiguities. For these states to evolve on the integers, we cannot have conventional process noise driving their behavior. Rather, this example embodiment assumes a discrete random walk is, where

$$p ( {q}_{k} , {r}_{k} , {s}_{k} ) = 𝒩 ( {q}_{k} ; 0 , {Q}_{k}^{ℝ} ( θ ) ) 𝒩 ( {q}_{k} ; 0 , {R}_{k} ) 𝒥 ( {s}_{k} ; a 1 , b 1 ) .$$

The last component drives the integer random walk, and this stochastic process will be explained further in the later sections on cycle slip detection.

The map B^{R} relating the process noise q to real-valued states 304d, and the map B^{Z} relating the integer jump noise s to the integer states 305d similarly contain many zero elements. It is recognized that in this and many other examples like those depicted in FIG. 1B and FIG. 1C, it is important to the estimation performance to correctly find the process noise covariance over the real-valued states 306d, and particularly the process noise related to the motion model 311d.

FIG. 3E details one embodiment of the cycle slip detection 340a algorithm used to determine the parameter dependence in the estimation model. Akin to the model synthesis, one embodiment takes measurements 310e from a satellite receiver 311e, which in the spirit of FIG. 2A may provide additional sensory information than simple GNSS signals. The measurement data 312e is subsequently used in combination with estimates 322e, computed concurrently or prior to the cycle slip detection, to determine if there is a significant measurement prediction error that can be attributed to any or many ambiguity dimensions. A set of such measurement errors 321e are computed for each time step in the batch, and subsequently a pre-defined threshold 330e is used to determine if a cycle slip has occurred from one time step to the next. If so, an indicator variable 331e for the given ambiguity at the given time is set high.

In one embodiment, the individual ambiguity dimensions with two different noise levels 340e, whose exact magnitude are taken to be a part of the variable model parameters in some embodiments of the disclosure. As such, the indicator variables 331 are used to fix the basis of the process noise of the estimation model and determine the parameter dependence without determining exactly what the parameters describing the high and the low noise levels are. In other embodiments, the indicator variable contains more than a binary state, and may describe the probability that a cycle slip even has occurred. Next, the indicator variable is further illustrated in relation to the time evolution of the integer biases.

FIG. 3F illustrates the probability density function of the integer jump noise s which drives the integer random walk used to model the integer ambiguities' time evolution in one embodiment of the disclosure and subsequently used in the first FGO. This noise gives rise to a dynamical system 303f where the integer biases sporadically jump to a different integer, before remaining at a constant integer for a long time. In relation to such an integer random walk process, it is naturally to approximate the discrete probability density function with two continuous Gaussian distributions 302f, 303f, when relaxing the estimation model and permitting the integer ambiguity estimates to reside on the real numbers. In one embodiment, the two distinct noise levels are used to inflate or reduce the process noise of a given ambiguity dimension in the relaxed estimation when a cycle slip is likely to have occurred. This high or low state is the parameter dependence that is fixed by the cycle slip algorithm

The ambiguities are likely to remain constant over long periods of time before single ambiguities suddenly jump to a new integer values during a cycle slip event. Some embodiments detect the cycle slip by modeling the ambiguity time evolution, i.e., the ambiguity motion model as a discrete random walk. In some embodiments, for an ambiguity n, the time evolution of the ambiguity and subsequent adaptive process noise 350a is modeled as the discrete random walk

$$\begin{matrix}{n}_{k} = {n}_{k - 1} + {\underline{v}}_{k - 1} , \\ {v}_{k - 1} \sim 𝒩 ( {v}_{k - 1} \vert 0 , {V}_{k - 1} ) , \\ {V}_{k - 1} = diag ( {c}_{k} {σ}_{jump}^{2} + ( 1 - {c}_{k} ) {σ}_{stay}^{2} ) ,\end{matrix}$$

Wherein

$${σ}_{jump}^{2}$$

is a variance reflecting the width of the domain of the integer jump process,

$${σ}_{stay}^{2}$$

is a regularization term, and C_{i,k} that determines whether a cycle slip has occurred.

In some embodiments, the difference between the satellite measurements and the predicted satellite measurements is formed to determine whether a cycle slip has occurred. For example, one embodiment forms the difference as

$$δ {y}_{k} = 𝔼 [ {\underline{y}}_{k} - {\underline{y}}_{k}^{f} ]$$

and recognize that between two consecutive time stamps, the most likely event that causes a sudden change in said difference is due to cycle slip. Hence, the difference equals

$$δ {y}_{k} = {G}_{k} δ {n}_{k} ⇔ δ {n}_{k} = {( {G}_{k}^{T} {G}_{k} )}^{- 1} {G}_{k} δ {y}_{k} ,$$

which means that if any dimension of the difference in ambiguity, δₙ_{ₖ}, is sufficiently far away from the origin, determined by a threshold d, it is because of a cycle slip. In one embodiment the incidence c_{i,k} is determined as

$${c}_{i , k} = \{ \begin{matrix}1 & if \vert δ {n}_{i , k} \vert > d \\ 0 & otherwise\end{matrix} .$$

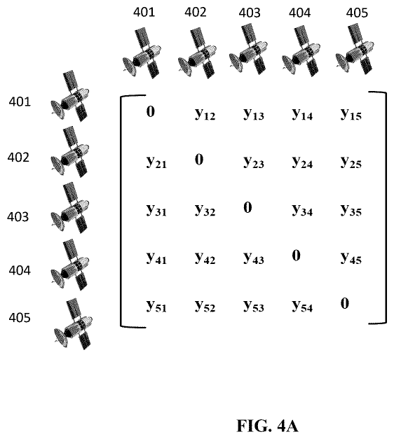

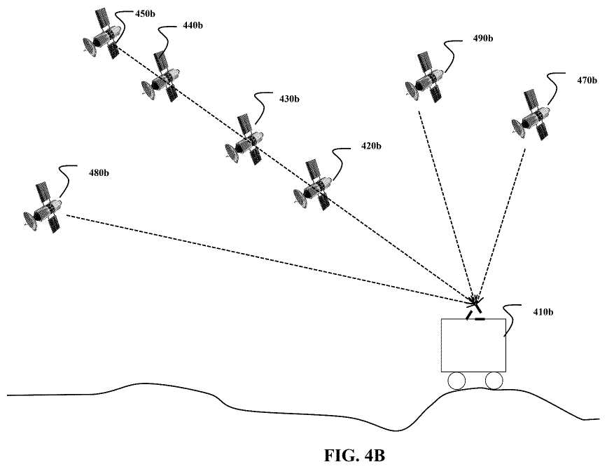

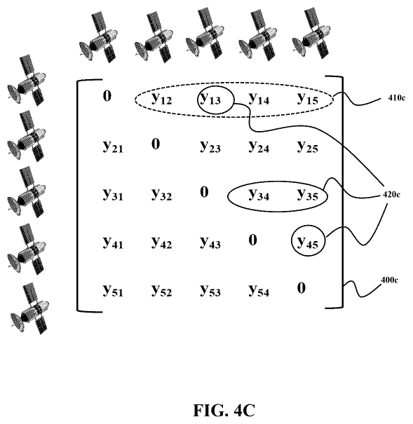

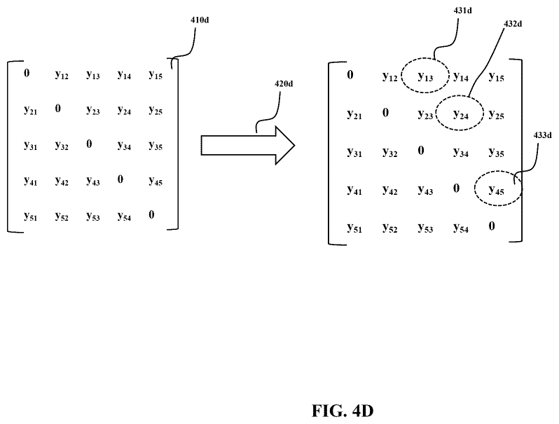

In some embodiments, the cycle-slip detection is done based on the estimates of the receiver states in a previous iteration, i.e., at a previous time step. The measurements of different combinations of satellites can be represented as the matrix in FIG. 4A, referred herein as a measurement matrix. Each element of the measurement matrix is an SD or DD measurement of at least one unique pair of satellites. Different satellites can be grouped in different pairs to increase dimensionality of the measurement matrix. Each measurement yᵢⱼ carries information that can be used for position estimation. To that end, it can be possible to use the measurement matrix in its entirety for position estimation. For example, using the satellite 101 as base receiver, SD measurements y₁₂, y₁₃, y₁₄, and y₁₅ can be formed. Similarly, using satellite 102 as base satellite, the corresponding SDs are y₂₁, y₂₃, y₂₄, and y₂₅. Generally, for M satellites and N frequencies there are (M−1)NM/2 possible combinations.

Some embodiments recognize that using all measurements of the measurement matrix can be computationally prohibitive for computationally limited receivers. In other words, in some situations, the dimensionality of the measurement matrix caused by availability of LOS satellites for the tracked GNSS receiver prohibitively increases computational complexity of position estimation filters. For instance, if there are multiple integer ambiguities that give good state estimation, it can be advantageous to execute multiple state estimators. As illustration, assume that there are M=10 unique pairs of code and carrier phase measurements, with five possible ambiguities that give good state estimation. This requires N_{S}=5M≈10⁷ state estimators to be executed in parallel. Hence, the computations can be overwhelming for a low-cost receiver.

Some embodiments are based on recognition that different elements of measurement matrix can have different informational value to the position estimation filter. For example, a pair of satellite positions on the same LOS with respect to the GNSS receiver has less informative value than a pair of satellites positioned on different LOS. This is because they provide the same geometric information of the receiver.

FIG. 4B shows a schematic illustrating a recognition of different embodiments that different measurements forming the measurement matrix can carry different amount of information. The figure shows a receiver 410b and seven satellites 420b through 490b. Assume that four satellites are to be used in the estimator. Satellites 420b, 430b, 440b, and 450b are located on the same line from the receiver 410b. They provide different distance measurements but from the same elevation angle, meaning that they have equal sensitivity to measurement noise. i.e., noise in the position measurement of the receiver. However, satellites 470b, 480b, and 490b have different elevation angles, meaning that measurement noise affects the uncertainties of receiver position differently. Hence, different satellites provide different information about the receiver position.

For example, in GNSS, the base satellite to use in the SD is the satellite with the highest elevation angle, because that satellite is likely to not have obstructions from multipath. Referring to FIG. 4C, if a satellite has the highest elevation angle, this means that the set 410c of measurements y₁₂, y₁₃, y₁₄, and y₁₅ are the measurements selected from the measurement matrix 400c to be used in the estimation. However, some embodiments are based on the understanding that there are multiple factors determining which satellite to use as base satellite, e.g., the physical positions and environmental disturbances of the satellites. Referring again to FIG. 4B, satellite 490b has the highest elevation angle of all the satellites. Hence, it is natural to form the SD as the difference between 490b and the other satellites and choose four SD measurements to use in the state estimator. However, instead it can be advantageous to form SD measurements using different satellites as base satellites, because it provides more geometric diversity among satellites.

Some embodiments are based on the realization that it is possible to select a predetermined number of measurements with maximum total information about the position. Because the number of selected measurements is predetermined from computational point of view, but the measurements are selected from available measurements based on informative value point of view, the selected combination provides maximum accuracy of state estimation while obeying the computational limitations of the receiver hardware. For example, instead of selecting measurements 410c, some embodiments select the subset of measurements 120f minimizing a loss of information with respect to the set of measurements. For example, the information is a cost function of the measurements used to estimate the position of the GNSS receiver. Hence, the loss of information is a difference between the cost function of having all measurements of the measurement matrix 400c as an input and the cost function of having the subset of measurements, e.g., subset 410c or 420c, as the input measurements.

The position of the receiver is part of the state of the receiver, which is unknown and estimated by the state estimator. A state estimator by nature produces a small error in position information. To that end, some embodiments are based on that the recognition that to determine the information of measurements, it is enough to know a coarse position of the receiver.

FIG. 4D illustrates the result from an optimization procedure for minimizing the loss of information of a subset of measurements with respect to the set of measurements according to one embodiment. The full measurement matrix 410d consisting of 10 unique measurements. In this example, based on a maximum number of measurements set to 3, minimizing 420d the loss of information results in measurements 431d, 432d, and 433d selected as the best measurements to use.

One embodiment realized that it is possible to quantify the information of measurements in probabilistic manner by the use of the Fisher information. The Fisher information is a way of measuring the amount of information that an observable random variable carries about an unknown parameter of a distribution that models the variable.

Some embodiments utilize the Fisher information matrix (FIM) to project the acquired measurements into a lower-dimensional subspace, formulating an optimization program to find the projected measurement that minimally degrades estimator performance with respect to the mean squared error (MSE) of the estimate. Using the projected measurements achieves a significant computational speedup while retaining the performance of the original estimator.

In one embodiment, the probabilistic measurement model is expressed as a Gaussian probability density function p(y; θ)= [symbol] (y; hₚ(θ),R), wherein hₚ is the deterministic part of the measurement model relating the position of the receiver to the measurement, θ is the position of the receiver expressed as a parameter, and R is the covariance of the measurement noise. For any unbiased estimate \hat{θ} of θ, the FIM [symbol] (y; θ) lower-bounds the variance of the estimation error according to

$$𝔼 [ {‖ θ - \hat{θ} ‖}_{2}^{2} ] = Tr ( 𝔼 [ ( θ - \hat{θ} ) {( θ - \hat{θ} )}^{T} ) ] > Tr ( {ℐ ( y : θ )}^{- 1} ) .$$

That is, the FIM gives a lower bound on how small the variation of the position estimate around the true position can be. The lower bound, i.e., the trace of the inverse of the FIM is denoted by the Cramer-Rao bound (CRB).

Accordingly, one embodiment minimizes the trace of the inverse of the FIM, Tr( [symbol] (y; θ)⁻¹, since it maximizes the information of the subset of measurements. This gives rise to a reduced FIM, which is the FIM of the reduced set of measurements, i.e., subset of measurements.

Some embodiments constrain the maximum number of measurements to a number \tilde{M}≤2 wherein M is the number of unique SD or DD carrier/code signals.

One embodiment is based on the understanding that to find the subset of measurements is the equivalent problem of finding a projection from the original set of measurements yₖ to a projected set of measurements, i.e., a subset of measurements \tilde{y}ₖ. One embodiment uses a projection operator Ψk; [symbol] → [symbol] according to \tilde{y}k=Ψₖ(yₖ), such that a maximal amount of information is retained in the projected measurements, i.e., the projection operator is chosen such that it minimizes the loss of information of the reduced FIM compared to the FIM using the full set of measurements.

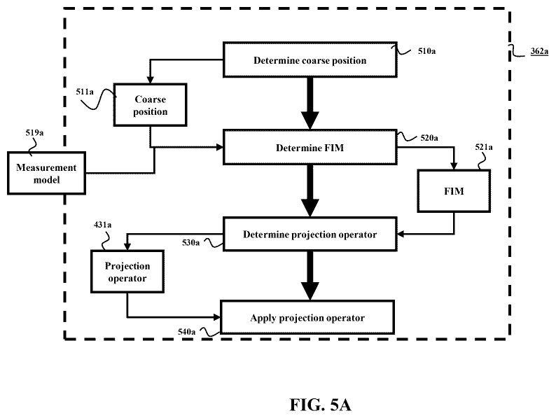

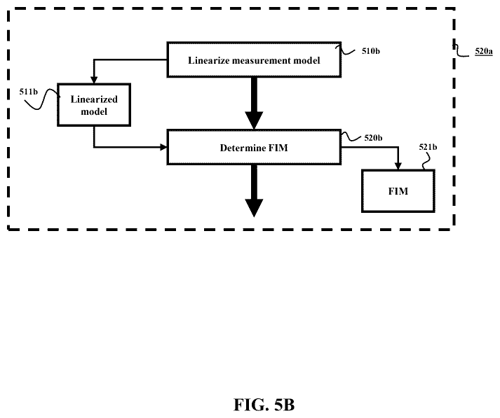

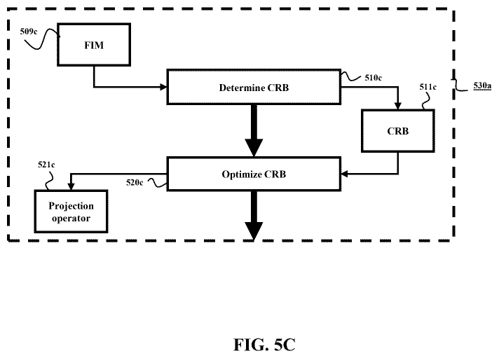

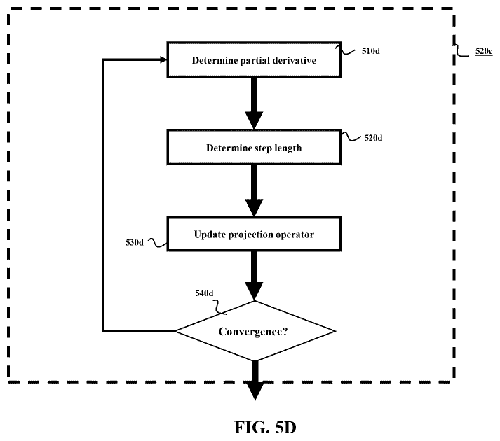

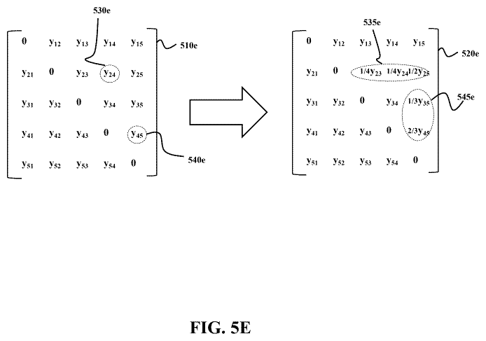

FIG. 5A shows a flowchart of a method 362a for selecting the subset of measurements according to one embodiment, wherein the method is executed by a processor. First, the method determines 510a a coarse position 511a of the receiver corresponding to at least one code signal. For instance, in one implementation the coarse position is determined by optimizing the fit of the coarse position to the code signals, e.g., by solving a least-squares problem. Using the coarse position 511a and the measurement model 519a, the method determines 520a the FIM 521a by inserting the coarse position into the measurement model. Next, the method determines 530a a projection operator 531a that reduces the FIM to a reduced FIM, i.e., an FIM of the subset of measurements with the size of the subset of measurements, by minimizing the loss of information in the reduced FIM with respect to the FIM of the full set of measurements. Finally, the method applies 540a the projection operator to the full measurement matrix to produce the subset of measurements.

FIG. 5B shows an implementation of a method 520a for the determining a reduced an FIM according to one embodiment. In general hₚ, i.e., the deterministic part of the measurement model relating the position of the receiver to the measurement, is nonlinear due to the distance calculation involved between receiver and satellites. In one embodiment, the method linearizes 510b the nonlinear measurement model around the coarse position. Next, using the linearized model 511b

$${H}_{p} = \frac{\partial {h}_{p} ( θ )}{\partial θ} {\vert}_{θ = {p}^{*}} ,$$

the method determines 520b the FIM 521b as a function of the projection operator Ψₖ: [symbol] → [symbol] , [symbol] (\tilde{y}, θ)=(ΨHₚ)^{T}(ΨRΨ^{T})⁻¹ΨHₚ.

Some embodiments are based on the understanding that the minimization of the CRB is a nonconvex optimization problem, where numerical methods are necessary. In one embodiment the determining the projection operator that optimizes the CRB is implemented iteratively until a termination condition is met.

FIG. 5C shows a flowchart of a method 530a for determining the projection operator to produce the subset of measurements according to some embodiments. First, the method 530a determines 510c the CRB 511c using the reduced FIM 509c. Next, In some embodiments, the method determines the CRB as the trace of the inverse of the reduced FIM, Tr(┌(ΨHₚ)^{T}(ΨRΨ^{T})⁻¹ΨHₚ┐⁻¹) i.e., by summing the diagonal elements of the inverse of the reduced FIM. Using the determined CRB 511c as a function of the projection operator, the method optimizes the CRB by selecting the projection operator that produces the optimal subset of measurements minimizing the loss of information relative to the full set of measurements, to find a projection operator 521cΨₖ: [symbol] → [symbol] projecting the full set of measurements to a subset of measurements \tilde{y}ₖ=:Ψₖ(yₖ).

The method is based on the understanding that the position is uncertain, but the uncertainty is much smaller than the distance between receiver and the satellites. For instance, an estimation of receiver position using code measurements results in an estimation error in the order of a few meters. However, the distance between a receiver and the satellites can be thousands of kilometers. One embodiment utilizes this to determine a coarse position, e.g., using code measurements, to determine the CRB as a function of input measurements.

FIG. 5D shows a flowchart of a method for optimizing the CRB finding the optimal projection operator finding the subset of measurements minimizing the loss of information according to one embodiment. The optimization problem of minimizing the CRB is formulated as

$${min}_{Ψ ∈ {ℝ}^{\tilde{M} \times M}} J ( Ψ ) ,$$

wherein J(Ψ)=Tr([(ΨHₚ)^{T}(ΨRΨ^{T})⁻¹ΨHₚ]⁻¹).

The optimization problem is solved using a gradient descent method and the method iterates until a convergence criterion is met. The method determines 510d a partial derivative of the CRB. One embodiment is based on the understanding that even though the CRB is a highly nonlinear function, its derivative can be determined as an analytic function

$$\begin{matrix}\frac{\partial Tr ( {ℐ ( \tilde{y} ; θ )}^{- 1} )}{\partial Ψ} = - 2 UQ {Λ}^{2} {Q}^{T} {V}^{T} \\ Y = {H}_{p}^{T} {{Ψ}^{T} ( Ψ R {Ψ}^{T} )}^{- 1} Ψ {H}_{p} , \\ U = {( Ψ R {Ψ}^{T} )}^{- 1} Ψ {H}_{p} , \\ {V}_{n} = {H}_{p} - R {Ψ}^{T} U ,\end{matrix}$$

and where Y=QΛQ^{T} and

$${H}_{p} = \frac{\partial {h}_{p} ( θ )}{\partial θ} {\vert}_{θ = {p}^{*}} .$$

One embodiment is based on the recognition that in order to determine the derivative, rank conditions need to be met. Another embodiment understands that the rank condition is met whenever there are at least 3 SD or DD satellite signals available. In one embodiment, this rank constraint is imposed by adding a rank constraint to the optimization problem.

Next, the method determines a step length 520d γ using a line search to control the movement of the solution along the direction of the gradient. In other words, controlling the step length guarantees convergence of the method to a local optimum.

Using the step length and derivative of CRB, the method updates 530d the projection operator by taking a step with length along the direction of the derivative of the CRB as a function of the projection operator. In one embodiment, this is done according to

$$\begin{matrix}{Ψ}_{k , n} = {Ψ}_{k , n - 1} + 2 γ {U}_{n} {Q}_{n} {Λ}_{n}^{- 2} {Q}_{n}^{T} {V}_{n}^{T} , \\ [ {Λ}_{n} , {Q}_{n} ] = eig ( {Y}_{n} ) , \\ {Y}_{n} = {H}_{p , k}^{T} {Ψ}_{k , n - 1}^{T} {U}_{n} , \\ {V}_{n} = {H}_{p , k} - {R}_{k} {Ψ}_{k , n - 1}^{T} {U}_{n} , \\ {U}_{n} = {( {Ψ}_{k , n - 1} {R}_{k} {Ψ}_{k , n - 1}^{T} )}^{- 1} {Ψ}_{k , n - 1} {H}_{p , k} , \\ {H}_{p} = \frac{\partial {h}_{p} ( θ )}{\partial θ} {\vert}_{θ = {p}_{k}^{*}} ,\end{matrix}$$

If the convergence criterion is met 540d, the method outputs the projection operator, and if not, the method determines 510d the partial derivative using the updated projection operator.

Some embodiments acknowledge the fact that even though linearization causes the CRB to be approximate, the linearization has negligible effect since the distance between satellite and receiver is large. In other words, using the coarse position, as long as the error is within a few meters, has little effect on the linearization error.

One embodiment is based on the understanding that from an algorithmic standpoint, the combination of satellites does not have to include full satellites. For instance, consider the case of having five satellites and choosing four of these. Then, it may be better to use a fourth of the measurement of the first satellite and three fourths of the fourth satellites, than to combine full satellite measurements. In other words, the combination of satellite measurements forming a measurement is a noninteger combination of satellites. Intuitively, this is because the FIM captures the uncertainty in the system, and although a combination of full satellites has highest probability, since there is some uncertainty about the correctness of such combination, it is safer from an MSE standpoint to choose noninteger combinations.

FIG. 5E shows a schematic of fractional measurement representations according to some embodiments. In this example, measurements of matrix 510e is represented as weighted combinations of different measurements 520e. For example, a measurement 530e is replaced with a weighted combination 535e, while a measurement 540e is replaced with a weighted combination 545e. Some embodiments are based on the recognition that the cost function is scale invariant, i.e., J(aΨ)=J(βΨ) for all β≠0, α≠0. Hence, the linear operator can be normalized to keep the magnitude of the projected measurements constant. For example, in some implementations, the weighted combination of different measurements is a combination such that all weights sum to one. In other implementations, the projection operator resulting from the optimization program is normalized, e.g., it is scaled to have unity norm. Doing such normalizations can be beneficial when implementing on embedded hardware with finite numerical precision.

One embodiment is based on the understanding that projecting the measurements into a subset of measurements will always mean a loss of information, i.e., the cost function J(Ψ) will never be smaller than J(I), as the linear combination of measurements cannot contribute any new information. In one embodiment, this understanding is used to determine the quality of the solution of the optimization program. E.g., if the ratio J(Ψ)/J(I)→1, the linear projection operator resulting from the optimization gives the same performance as when using the full set or measurements. Similarly, if the ratio is large, the optimized projection operator is suboptimal and will lead to degraded performance. Hence, when the ratio is large, one embodiment increases the allowed maximum number of measurements in the subset of measurements to find a better projection operator. In some implementations, this procedure is iterated until a suitable ratio has been determined.

Some embodiments realize that to perform simultaneous measurement reduction on both code and carrier phase measurements can give problem with estimation, as information is removed from the estimation problem by removing measurements, leading to issues with observability of some states, e.g., parts of the ambiguities and/or positions cannot be estimated at the same time, leading to drift in the measurements. However, several embodiments resolve these issues by various implementations.

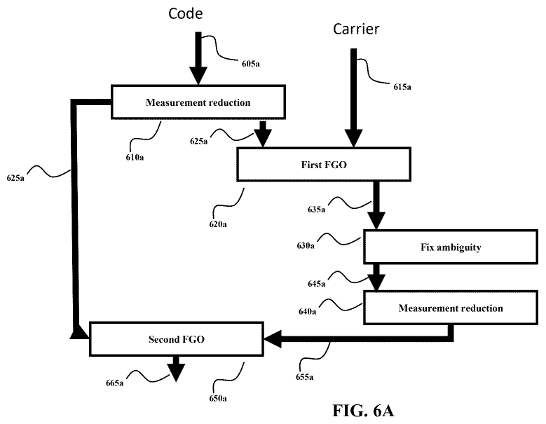

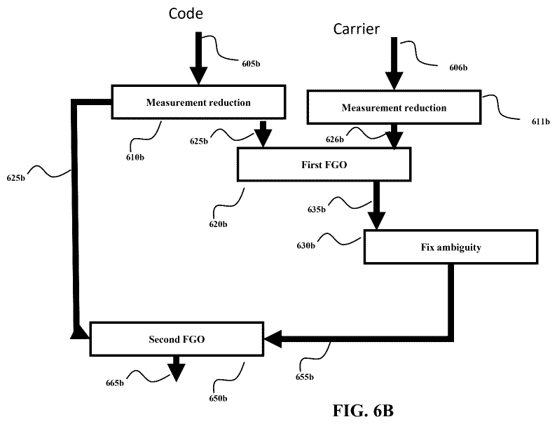

FIG. 6A shows a flowchart of one iteration of a method for FGO-based positioning using measurement reduction. It is recognized that such method can incorporate adaptive process noise on the ambiguities, but it is not mandatory. The method first uses a measurement reduction on the code measurements only, reducing size of the code measurements but not the carrier phase measurements. Such one sided reduction is done to reduce computational complexity somewhat, without loosing performance significantly. First, the method receives code measurements 605a, which it reduces 610a the dimension of, e.g., using the embodiments described previously. Next, using the reduced-dimension code measurements and the carrier phase measurements, 615a, the method executes 620a a first FGO to produce float receiver states and ambiguities 635a. Next, the method fixes 630a the ambiguities. Using the fixed 645a integer ambiguities and the receiver states, the method now performs a measurement reduction 640a on the carrier phase measurements using the fixed ambiguities inserted into the measurement model. Next, using the reduced measurements 655a of carrier phase and reduced measurements 625a of code, the method executes a second FGO 650a to produce the receiver estimates 665a.

FIG. 6B shows a flowchart of one iteration of an alternative method for FGO-based positioning using measurement reduction. It is recognized that such method can incorporate adaptive process noise on the ambiguities, but it is not mandatory. The method uses a measurement reduction on the code and carrier phase independently of each other, reducing size of the code measurements and the carrier phase measurements. Such reduction is done to reduce computational complexity further, without losing observability of the considered problem. First, the method receives code measurements 605a and carrier phase measurements 606b, which it reduces 610b and 611b the dimension of independently, e.g., using the embodiments described previously. Next, using the reduced-dimension code measurements 625b and the reduced-dimension carrier phase measurements 626b, the method executes 620b a first FGO to produce float receiver states and ambiguities 635b. Next, the method fixes 630b the ambiguities. Using the fixed 655b integer ambiguities and the receiver states, the method executes a second FGO 650a to produce the receiver estimates 665b.

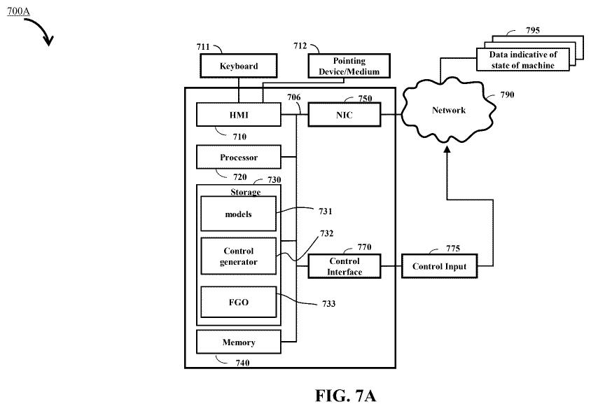

FIG. 7A shows a block diagram of a system 700A for joint tracking and/or control of receivers such as vehicles or aquatic buoys in accordance with some embodiments. The system 700A can have a number of different interfaces connecting the system 700A with other machines and devices. A network interface controller (NIC) 750 includes a receiver adapted to connect the system 700A through the bus 706 to a network 790 connecting the system 700A to receive GNSS and other sensory data from the receivers.

In some implementations, the system is configured only to track the state of the one or more receivers. In some embodiments where the receivers are attached to mobile vehicles, the system is configured to further control the motion of the vehicle either individually or as a platoon. To that end, in some embodiments, the system 700A is configured to receive the traffic state of a group of mixed-autonomy vehicles traveling in the same direction, wherein the group of mixed-autonomy vehicles includes controlled vehicles willing to participate in a platoon formation and at least one uncontrolled vehicle, and wherein the traffic state is indicative of a state of each vehicle in the group and the controlled vehicle. For example, in one embodiment the traffic state includes current headways, current speeds, and current acceleration of the mixed-automata vehicles. In some embodiments, the mixed-automata vehicles include all uncontrolled vehicles within a predetermined range from flanking controlled vehicles in the platoon.

The NIC 750 also includes a transmitter adapted to transmit the control commands to the controlled vehicles via the network 790. To that end, the system 700A includes an output interface, e.g., a control interface 770, configured to submit the control commands 775 to the controlled vehicles in the group of mixed-autonomy vehicles through the network 790. In such a manner, the system 700A can be arranged on a remote server in direct or indirect wireless communication with the mixed-automata vehicles.

The system 700A can also include other types of input and output interfaces. For example, the system 700A can include a human-machine interface 710. The human-machine interface 710 can connect the controller 750 to a keyboard 711 and pointing device 712, wherein the pointing device 712 can include a mouse, trackball, touchpad, joystick, pointing stick, stylus, or touchscreen, among others.

The system 700A includes a processor 720 configured to execute stored instructions, as well as a memory 740 that stores instructions that are executable by the processor. The processor 720 can be a single-core processor, a multi-core processor, a computing cluster, or any number of other configurations. The memory 740 can include random access memory (RAM), read-only memory (ROM), flash memory, or any other suitable memory machines. The processor 720 can be connected through bus 706 to one or more input and output devices.

The processor 720 is operatively connected to a memory storage 730 storing the instructions as well as processing data used by the instructions. The storage 730 can form a part of or be operatively connected to the memory 740. For example, the memory can be configured to store probabilistic estimation model 731, the FGO algorithms and related data 733, and, optionally, control generator 732.

The processor 720 is configured to determine control commands for the controlled vehicles that indirectly control the uncontrolled vehicles as well. To that end, the processor is configured to execute a control generator 732 to determine control commands based on the state of the vehicles. In some embodiments, the control generator 732 uses a deep reinforcement learning (DRL) controller trained to generate control commands from the augmented state for an individual and/or a platoon of vehicles.

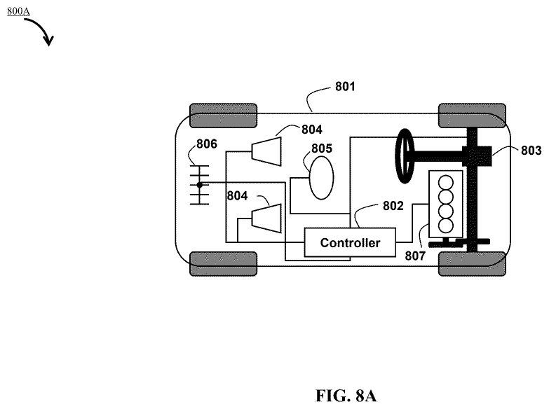

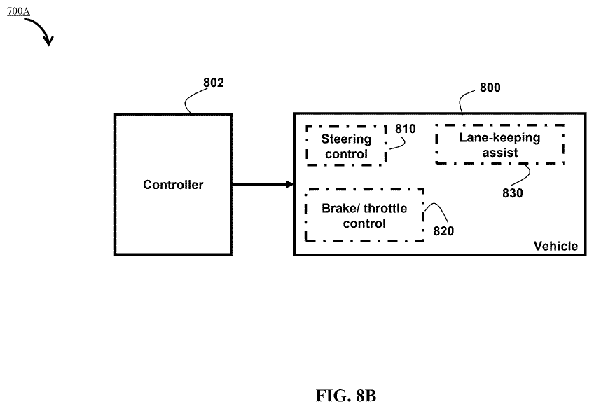

FIG. 8A shows a schematic of a vehicle 801 controlled directly or indirectly according to some embodiments. As used herein, vehicle 801 can be any type of wheeled vehicle, such as a passenger car, bus, or rover. Also, vehicle 801 can be an autonomous or semi-autonomous vehicle. For example, some embodiments control the motion of vehicle 801. Examples of the motion include the lateral motion of the vehicle controlled by a steering system 803 of the vehicle 801. In one embodiment, the steering system 703 is controlled by the controller 802 in communication with the system 700A. Additionally or alternatively, the steering system 803 can be controlled by a driver of vehicle 801.

The vehicle can also include an engine 807, which can be controlled by the controller 802 or by other components of the vehicle 801. The vehicle can also include one or more sensors 804 to sense the surrounding environment. Examples of the sensors 804 include distance range finders, radars, lidars, and cameras. The vehicle 801 can also include one or more sensors 805 to sense its current motion quantities and internal status. Examples of the sensors 805 include GNSS signals, accelerometers, inertial measurement units, gyroscopes, shaft rotational sensors, torque sensors, deflection sensors, pressure sensor, and flow sensors. The sensors provide information to the controller 802. The vehicle can be equipped with a transceiver 806 enabling communication capabilities of the controller 802 through wired or wireless communication channels.

FIG. 8B shows a schematic of interaction between the controller 802 receiving controlled commands from the system 700A and the controller 800 of the vehicle 801 according to some embodiments. For example, in some embodiments, the controllers 800 of the vehicle 801 are steering 810 and brake/throttle controllers 820 that control rotation and acceleration of the vehicle 801. In such a case, the controller 802 outputs control inputs to the controllers 810 and 820 to control the state of the vehicle. The controllers 800 can also include high-level controllers, e.g., a lane-keeping assist controller 830 that further processes the control inputs of the predictive controller 802. In both cases, the controllers 800 maps use the outputs of the predictive controller 802 to control at least one actuator of the vehicle, such as the steering wheel and/or the brakes of the vehicle, to control the motion of the vehicle. States of the vehicular machine could include position, orientation, and longitudinal/lateral velocities; control inputs could include lateral/longitudinal acceleration, steering angles, and engine/brake torques. State constraints on this system can include lane-keeping constraints and obstacle avoidance constraints. Control input constraints may include steering angle constraints and acceleration constraints. Collected data could include position, orientation, velocity profiles, accelerations, torques, and/or steering angles.

The above-described embodiments of the present disclosure can be implemented in numerous ways. For example, the embodiments may be implemented using hardware, software, or a combination thereof. When implemented in software, the software code can be executed on any suitable processor or collection of processors, whether provided on a single computer or distributed among multiple computers. Such processors may be implemented as integrated circuits, with one or more processors in an integrated circuit component. Though, a processor may be implemented using circuitry in any suitable format.

Also, the various methods or processes outlined herein may be coded as software that is executable on one or more processors that employ any one of a variety of operating systems or platforms. Additionally, such software may be written using any of several suitable programming languages and/or programming or scripting tools and may be compiled as executable machine language code or intermediate code that is executed on a framework or virtual machine. Typically, the functionality of the program modules may be combined or distributed as desired in various embodiments.

In addition, the disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments.

Although the disclosure has been described by way of examples of preferred embodiments, it is to be understood that various other adaptations and modifications can be made within the spirit and scope of the disclosure. Therefore, it is the object of the appended claims to cover all such variations and modifications as come within the true spirit and scope of the disclosure.

1. A system for probabilistically tracking a state of a receiver of a global navigational satellite system (GNSS), comprising: a processor; and a memory having instructions stored thereon that, when executed by the processor, cause the system to:
receive GNSS measurement data transmitted from a plurality of satellites, including carrier phases and code signals;
process the GNSS measurement data to detect irregularities;
track the state of the receiver using an adaptive probabilistic estimator iteratively predicting the state of the receiver using a state estimation model of the receiver subject to process noise and updating the state of the receiver using a measurement model processing the GNSS measurement data subject to measurement noise, wherein the adaptive probabilistic estimator is configured to vary the process noise in response to detecting the irregularities in the GNSS measurement data; and
output the tracked state of the receiver.

2. The system of claim 1, wherein to detect irregularities the processor is configured to one or a combination of:
detect cycle slips by analyzing discrepancies between predicted and actual measurements in the GNSS measurement data; and
identify multipath effects based on abnormal signal reflections or noise patterns.

3. The system of claim 1, wherein the processor is configured to:
accept a batch of measurements indicative of motion of the receiver, the batch of measurements including the GNSS measurement data collected over a sequence of time instances within a time period;
monitor the measurement data for indicators of signal irregularities, including one or a combination of cycle slips and multipath effects;
dynamically adjust parameters of the process noise in the state estimation model of the adaptive probabilistic estimator based on detected indicators, wherein higher process noise values are applied to state variables of the GNSS receiver affected by the detected irregularities, and lower process noise values are maintained in absence of the detected irregularities; and
estimate and output a trajectory of the GNSS receiver tracked within the batch of measurements using different parameters of the process noise while preserving at least some measurements from the batch of measurements for each of the instances of time in the time period to maintain a continuity of measurements in the batch of measurements.

4. The system of claim 3, wherein the batch of measurements includes one or a combination of readings of an internal measurement unit (IMU), barometric, and ranging data measurements.

5. The system of claim 3, wherein the adaptive probabilistic estimator performs two-stage tracking including a first stage and a second stage,
wherein, during the first stage, the adaptive probabilistic estimator estimates the trajectory of the GNSS receiver using a real-valued ambiguity of the GNSS measurement data to optimize the state trajectory for the real-valued ambiguity in an objective function to minimize an error between a combination of a code factor, a carrier factor, a motion constraint factor, an ambiguity constraint factor; and
wherein, during the first stage, the adaptive probabilistic estimator fixes the real-valued ambiguity to a closest integer value and estimates the trajectory of the GNSS receiver using integer-value ambiguity of the GNSS measurement data.

6. The system of claim 3, wherein the adaptive probabilistic estimator is configured to:
process the batch of measurements with a first factor graph optimization (FGO) to estimate the state trajectory of the receiver for the time period explaining the measurements in the batch of measurements according to the state estimation model with the varying process noise, wherein the first FGO optimizes for real-valued receiver state and real-valued ambiguity in an objective function to minimize an error between a combination of a code factor, a carrier factor, a motion constraint factor, an ambiguity constraint factor;
fix the ambiguity to an integer value; and
processes a second FGO based on the measurements and the fixed integer ambiguity to estimate the state trajectory of the GNSS receiver.

7. The system of claim 6, wherein the first FGO incorporates adaptive priors of the integer ambiguity, such that the adaptive probabilistic estimator determines the importance of each measurement in the optimization process based on indicators of irregularities.

8. The system of claim 6, wherein the first FGO utilizes a Fisher information matrix to identify a subset of measurements that maximizes the total information about the state of the GNSS receiver and requires a reduced number of computations for processing than an entire set of measurements.

9. The system of claim 6, wherein the system dynamically selects a predetermined number of measurements from a measurement matrix based on their informational value, wherein the informational value is determined as a function of relative line-of-sight geometry of the satellites with respect to the GNSS receiver.

10. The system of claim 9, wherein the selected measurements include one or a combination of single differenced and double differenced measurements of satellite signals to ensure maximum spatial diversity.

11. The system of claim 6, wherein the adaptive probabilistic estimator projects the measurements into a lower-dimensional subspace using a Fisher information matrix to reduce computational load of the first FGO, the second FGO, or both.

12. The system of claim 6, wherein the second FGO refines the estimated trajectory by compensating for residual errors arising from the fixed integer ambiguities using statistical smoothing methods.

13. The system of claim 3, wherein the adaptive probabilistic estimator dynamically adjusts batch length based on computational capacity, signal quality, and detected irregularities in the GNSS measurement data.

14. The system of claim 9, wherein the selection of measurements is performed using a non-integer combination of satellite measurements, wherein a weighted fraction of signals from different satellites is combined to minimize mean squared error (MSE) of the trajectory estimate.

15. A method for tracking a state of a receiver of a global navigational satellite system (GNSS) using two-stage factor graph optimization (FGO), the method comprising:
receiving a batch of GNSS measurement data from a plurality of satellites, the data including carrier-phase signals and code signals collected over a sequence of time instances;
detecting signal irregularities, including one or more of cycle slips and multipath effects, by analyzing discrepancies between predicted and measured signals in the GNSS data;
executing a first FGO to estimate a trajectory of the receiver state and real-valued ambiguities, wherein the first FGO optimizes an objective function that minimizes errors associated with carrier-phase factors, code factors, motion model factors, and ambiguity factors;
resolving integer ambiguities by fixing the real-valued ambiguities to their closest integer values; and
executing a second FGO using the fixed integer ambiguities to refine the trajectory of the receiver state.

16. The method of claim 15, further comprising:
dynamically adjusting process noise parameters of a state evolution model in the first FGO based on detected irregularities, wherein higher process noise is applied to state variables affected by the irregularities, and lower process noise is applied to variables with clean measurements.

17. The method of claim 15, wherein detecting signal irregularities comprises:
computing differences between predicted and measured carrier-phase signals to identify cycle slips; and
analyzing noise patterns or signal reflections to identify multipath effects, and selectively adjusting contribution of affected measurements to the optimization process.

18. The method of claim 15, further comprising:
selecting a subset of measurements from a measurement matrix formed by single or double differenced signals from pairs of satellites, wherein the subset is selected based on maximizing a Fisher information matrix (FIM) to preserve maximum informational value while reducing computational complexity.

19. The method of claim 15, further comprising:
projecting the measurements into a lower-dimensional subspace using a Fisher information matrix and an optimization procedure, wherein the optimization minimizes a Cramer-Rao bound (CRB) to ensure minimal loss of information and reduced computational load during the two-stage estimation process.

20. The method of claim 15, wherein the receiver is arranged on a vehicle, further comprising:
adjusting batch length of GNSS measurement data used in the two-stage factor graph optimization based on computational capacity and signal quality, wherein the batch length is reduced in response to increased computational load or degraded signal conditions to ensure real-time processing performance.
